(19) United States
(12) Patent Application Publication
(10) Pub. No.: US 2002/0186384 A1
(43) Pub. Date: Dec. 12, 2002

(54) Splitting a print job for improving print speed

(76) Inventors: Edward G. Winston, Austin, TX (US); Joe A. Wallace, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/876,080

(22) Filed: Jun. 8, 2001

(51) Int. Cl. B41J 1/00; G06F 15/00

(52) U.S. Cl. 358/1.5; 358/1.15

(57) ABSTRACT

A computer based method is described for maximizing printing speed of a print job. The method comprises the steps of locating pages in the print job, creating an index of information relating to the locations of the pages in the print job, determining if the pages in the print job meet a criteria based on the information in the index, splitting the print job into a plurality of sets of pages if the pages in the print job meet the criteria, and delivering said plurality of sets of pages to a plurality of printers, respectively, based on the information in the index.

### FIELD OF THE INVENTION

The present invention relates generally to a technique for improving printing speed, and more particularly, to a method and system for splitting a print job across available printers for improving printing speed.

### BACKGROUND OF THE INVENTION

In a network system such as a local area network (LAN), a group of computers are linked together to allow each computer to exchange email, transfer files, share software applications, do video conferencing and use the same printers. In a typical network, each computer is assigned a dedicated printer for printing print jobs. The print job may be in the form of a single document, multiple-copy document or multiple documents. The print job may be submitted via the network by Unix, mainframe or Windows based applications. Print jobs from such applications are converted to Postscript to facilitate processing and printing by a Postscript interpreter printer.

In most business environments today, large print jobs are quite common and high-throughput is desired. However, network printers are too slow to handle large printer jobs. There are commercially available high-speed printers that may be used to improve printing speed, but such printers are costly to purchase and to maintain. There is currently a need for an inexpensive technique for improving the printing speed of a print job via a LAN.

### SUMMARY OF THE INVENTION

Briefly, the present invention comprises in one embodiment a computer based method for maximizing printing speed of a print job, comprising the steps of: locating pages in the print job; creating an index of information relating to the locations of the pages in the print job; determining if the pages in the print job meet a criteria based on the information in the index; splitting the print job into a plurality of sets of pages if the pages in the print job meet the criteria; and delivering said plurality of sets of pages to a plurality of printers, respectively, based on the information in the index.

In another embodiment of the present invention, a computer program that causes a computer to perform a method for maximizing printing speed of a print job, the method comprising the steps of: locating pages in the print job; creating an index of information relating to the locations of the pages in the print job; determining if the pages in the print job meet a criteria based on the information in the index; splitting the print job into a plurality of sets of pages if the pages in the print job meet the criteria; and delivering said plurality of sets of pages to a plurality of printers, respectively, based on the information in the index.

In yet another embodiment of the present invention, a computer is used to improve printing speed of a print job in a computer system, comprising: a first component for locating pages in the print job; a second component for creating an index with information relating to the locations of the pages in the print job; a third component for determining if the pages in the print job meet a criteria based on the information in the index; a fourth component for splitting the print job into a plurality of sets of pages if the pages in the print job meet the criteria; and a fifth component for delivering said plurality of sets of pages to a plurality of printers, respectively, based on the information in the index.

In yet another embodiment of the present invention, a system is provided that is coupled to a computer network for printing a print job sent by a user connected to the network. The system comprises: a plurality of printers; and a computer coupled to the printers for improving printing speed of the print job. The computer comprises: a first component for locating pages in the print job; a second component for creating an index with the locations of the pages in the print job; a third component for determining if the pages in the print job meet a criteria based on the information in the index; a fourth component for splitting the print job into a plurality of sets of pages if the pages in the print job meet the criteria, and a fifth component for delivering said plurality of sets of pages to the plurality of printers, respectively, based on the information in the index.

### BRIEF DESCRIPTION OF THE DRAWINGS

The accompanying drawings, which are incorporated herein and constitute a part of the specification, illustrate a presently preferred embodiment of the invention, and together with the general description given above and the detailed description of the preferred embodiment given below, serve to explain the principals of the invention.

FIG. 1 is a block diagram illustrating a system of components incorporating the preferred embodiment of the present invention.

FIG. 2 is a flow diagram of the method for implementing the preferred embodiment of the present invention.

### DETAILED DESCRIPTION OF THE PREFERRED EMBODIMENTS

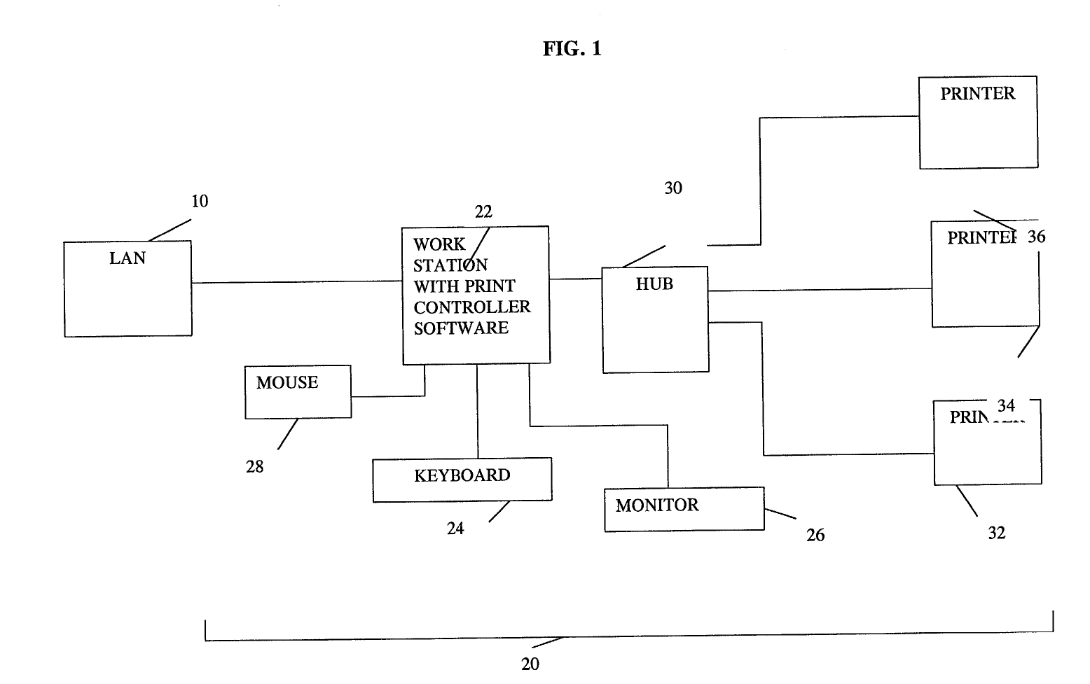

Referring now to FIG. 1, there is shown a server-based LAN 10 in which a server stores application software and files and routes shared information to several personal computers in LAN 10. The server includes the customary components of a computer system including a CPU, a display or other I/O device, a network or communications interface, RAM or ROM or other memory, as well as stable storage devices such as disk or CD-ROM drives. A server-based LAN is preferred but other LANs may be employed for achieving communication between personal computers such as peer-to-peer networks. The most common software choices today for small companies seeking a server-based LAN is either Microsoft Windows NT or Novell Netware.

In FIG. 1, there is also shown system 20 for implementing the present invention. System 20 includes workstation 22, keyboard 24, monitor 26, mouse 28, network hub 30 and Postscript printers 32,34,36. Workstation 22 is connected to LAN 10 to receive print jobs that were created by the personal computers in LAN 10. Workstation 22 includes the customary components of a computer including a CPU, a network or communications interface/card, RAM or ROM or other memory, as well as stable storage devices such as disk or CD-ROM drives. A Windows NT operating system is installed in workstation 22 along with the print controller software for implementing the process of the present invention, as discussed below.

In system 20, network hub 30 (and network cables) is used to connect PostScript printers 32,34,36 to workstation 22. Each printer has a network card to allow workstation 22 and printers 32,34,36 to communicate with LAN 10. Network hub 30 may have additional ports for additional printers. It is noted that three printers are employed in the preferred embodiment. However, two or more printers may be used, limited only by the number of ports in network hub 30.

As discussed above, the print controller software is used to implement the process of the present invention. In order to configure the print controller software, the appropriate network properties of LAN 10 must be obtained such as the host name and IP address for workstation 22 and the IP addresses for printers 32,34,36. Workstation 22 is configured with a default host name. During the initial configuration, the administrator may select the default host name or change it when configuring IP addresses. This activity is performed once during the initial configuration. This enables the print controller software to connect to the printers. Standard network procedures are used to add an IP address for workstation 22. All information is entered by the keyboard 24 and mouse 28. In one configuration, the administrator will then configure workstation 22 to recognize printers 32,34,36, such as by double clicking on an administration tool or icon. The administrator will select “configuration” on the menu and add printers 32,34,36 one by one with the appropriate IP addresses.

After initial configuration, an administrator may double click on the administration tool or icon to open the print controller software. In one example embodiment, the administrator may choose one of four options in the configuration menu: add or delete printers, enable or disable printers, adjust print splitting properties, and shut or restart the print controller software. When configuring print splitting properties, an administrator will set a threshold value to determine how many pages a print job must contain to be split or will set some other threshold value, such as ink type requirements (some pages may have different color ink than other pages), or different sheet material requirements for different pages, or some other means of splitting pages among printers. That is, the pages in the print job must exceed the threshold value in order to be split. For purposes of this discussion, the word “page” means “sheet” because one page is printed per sheet. If several pages are printed per sheet however, the print control software splits the job by quantity of sheets. Normally, a page is information on a printed sheet that is assigned a page number. In some instances, however, a page may be a printed sheet that contains multiple page images. Print splitting will be discussed in more detail below. The administrator will then set the number of printers.

When print jobs are sent through LAN 10, the print job may be executed from a different operating system such as Windows (NT, 2000, 98 or 95) or UNIX. Each system must therefore be configured or set up for the printers. For purposes of this discussion however, Windows will only be discussed. (UNIX may also be configured by defining the network printer as a remote printer, as known by those skilled in the art.) To set up the printers in Windows, a user must double click the “Add Printer” icon to access the Add Printer Wizard box and choose the network printer server. The user then must select the network printer selected by the administrator (default or designated name) for accessing the print controller software on workstation 22. The software will then download the appropriate printer driver.

In the printer set up for the network printer, the user must select the “optimize for portability” option to ensure that the print job is printed correctly and accurately as created. To accomplish this in Windows NT for example, the user selects the printer already installed, right clicks on the printer for the drop down menu, selects the Document Defaults and selects the “Advanced” tab at the top of this window. The user then selects “Postscript Options” in the list. In the change “Postscript Output Option” setting at the bottom of the box, the user selects “Optimize for Portability” and clicks “OK.” A similar procedure is performed in other versions of Windows to access the PostScript output option for optimizing the printing of a job for portability.

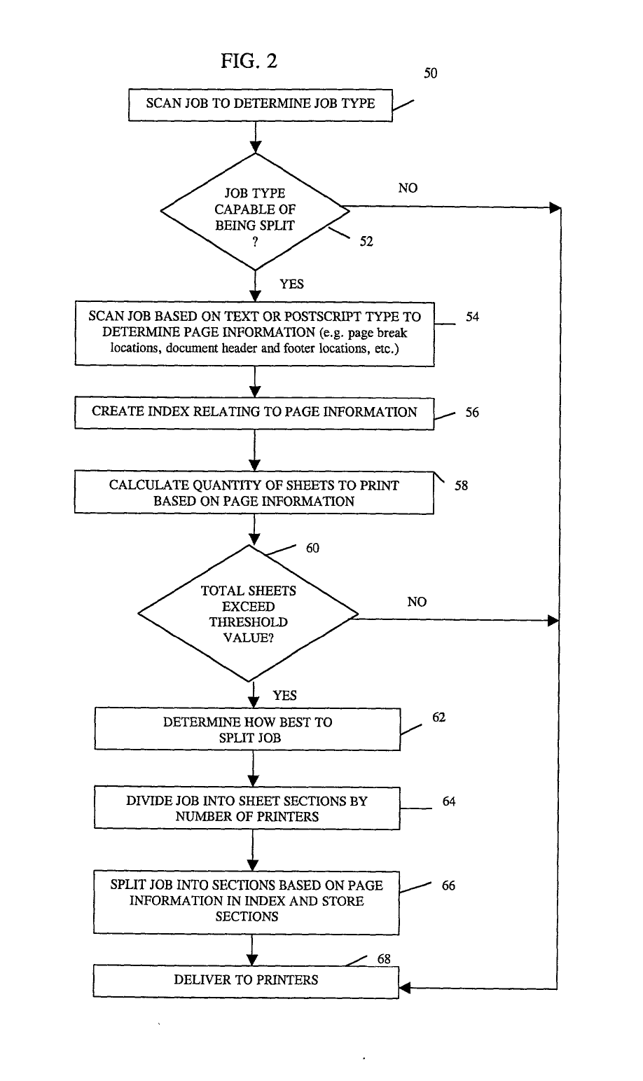

As discussed above, the print controller software is used to implement the method of the present invention. The print controller software uses “C” programming computer language to implement the method. However, any appropriate computer language may be used for the implementation. Referring to FIG. 2, there is shown a flowchart of the execution of method for implementing the present invention. As part of the print controller software, there is preferably a configuration file used by the method to interpret different Postscript codes or markers. However, this information could be built into the print controller software.

The first step 50 in the flowchart is to scan the print job to determine the type of print job. This is accomplished in the present example by searching a predetermined set of bytes, such as through the first 1K bytes (“first string”) of the job for particular markers associated with recognized Postscript formats. In the preferred embodiment, print jobs of Postscript format are identified by “%%” keys in the initial keys of the first string. If the “%%” keys are not found, the print job is treated as a plain text file.

Print jobs that are identified as Postscript are also identified by the type of Postscript. In the present example implementation, the print controller software recognizes the following Postscript formats: Windows, Platinum, Crystal Reports, SAP R/3 3.0A, Oracle Toolkit 2 and SQR.

For Windows NT Adobe version 5 for example, the first string of the Postscript may be searched for the following markers or keys:

AdobePS5dll Version

Pscript_WinNT_ErrorHandler

Searching continues until a particular Postscript type is matched with markers associated with the Postscript types recognized by the print controller software. There are particular markers associated with each Postscript type for identification.

Now, the execution then moves to decision block 52 wherein it is determined if the job type is capable of being split. If a match to the Postscript format is found during the search, the type of Postscript format for the job is determined and all markers or keys associated with that Postscript format are used to configure the job for printing. If the format type of the print job is not recognized, e.g., the answer is NO, then the print job is not capable of being split and the job is sent directly to a printer for printing represented by block 68. Additionally, the print job may include specific markers that render the print job un-splittable, and thereby cause the job to be sent directly to block 68. By way of example but not by way of limitation, the un-splittable marker may be “%% Page Order: Special.”

If the answer to decision block 52 is YES, execution then moves to block 54 wherein the entire print job is scanned, line by line, to determine page information, such as page breaks and other data required for printing. That is, the print job is searched to find particular keys or markers, i.e., character strings that are associated with a page break and other characteristics important for printing properly (duplex printing (meaning on both sides of a sheet), collated printing, and “nup” printing (number of pages printed on face of a sheet of paper)).

The particular markers or character string associated with an instruction, such as a page break, depends upon the type of Postscript format. For jobs in Windows NT Adobe Version 5, page breaks are identified by the marker “%% PageTrailer.” For jobs in Windows NT 3.5 PS Driver, page breaks are identified by “showpage.” Importantly, the job is scanned for markers associated with the particular Postscript type identified in the predetermined string, such as the first string of the job in this example. It is important to note that if the job is document structuring conventions (“DSC”) compliant, then standard markers known to those skilled in the art are used for searching to identify printing characteristics.

If the print job is identified as a plain text file, the job is merely scanned for markers to identify page breaks only. Plain text files do not include markers or keys associated with complex printing functions such as duplex printing, collated printing, etc. Page break markers include “form feed” or “control L,” which means go on to the next page.

The execution then moves to block 56, wherein page information including the exact locations of the individual pages is stored in an index. The header and footer locations for the entire document are also stored in the index. Other print instructions required for printing are also stored in the index. Such location information is extracted during the search described above in relation to block 50. In all print jobs of Postscript format, it is presumed that the header information appears before the first page break and footer information is presumed to appear after the final page break.

The execution then proceeds to block 58, wherein the total quantity of sheets to be printed is calculated. This calculation is based on the page information in the index (created in block 56) such as duplex, collate, and “nup” (number of pages to print on a face of sheet) instructions and the total number of pages. A print job may comprise one document or several collated or uncollated copies of a document. For example, if a print job is a single document of 30 pages with a duplex instruction, the total quantity of sheets to be printed is 15 (a page on each face of a sheet side). Note however that, in this example embodiment, a sheet may correspond to a page if only one page is printed per sheet. In general, however, the term “page” may be used interchangeably with “sheet.”

The execution then moves to decision block 60, wherein it is determined if the total quantity of sheets exceeds the threshold value set by the administrator during initial configuration, or whether some other criteria or threshold set by the administrator relating to ink, media type, or other characteristic is met. To accomplish this for a threshold relating to number of sheets, the total quantity of sheets is compared to the threshold value. This comparison may be performed regardless of whether the print job is a single document or multiple collated or uncollated copies of a single document. The size and number of documents in a print job will however affect how the job is split. This will be discussed below. Now, if the answer to decision block 60 is NO, the entire job is sent to block 68 to be printed.

If the answer to block 60 is YES, execution then proceeds to decision block 62, wherein it is determined how best to split the print job. To accomplish this task in one example, page information from the index is used, e.g., collate, copy number instructions, etc. For example, if the job is a single document or multiple uncollated copies, based on the page information in the index, the job is split by the total quantity of sheets. If the job is multiple collated copies of a single document, then the job is split by copies.

Execution then proceeds to block 64 wherein the job is divided among the printers based on a criteria. By way of example but not by way of limitation, if the criteria is an appropriately even split of sheets among printers, then the job is divided into equal sections (nearest amount) by the number of printers. For this criteria example, if there are 30 sheets in a job (1 page per sheet), the job is split into 3 groups or sections of 10 sheets. If the job is a 6 collated copies of a document consisting of 5 sheets, then the job is split into 3 sets with each set comprising 2 copies of the document. As noted above, if the criteria is ink type, or media type, then the split may be based on the ink or media type used with that printer.

Execution then proceeds to block 66, wherein the job is actually split into sections based on the page information in the index and is subsequently stored in separate files along with the header and footer information for the entire job. Note that the header and footer information corresponding to the individual pages (as opposed to the document header and footer information) are also stored in those separate files along with each page. As discussed, the document header information extends from the beginning of the document (0 byte) to the end of page 1 (page break). The document footer information appears below the final page break in that document. In the example above, three sets of 10 sheets are stored in three separate files,

Execution finally proceeds to block 68, wherein each (separate) file is delivered to the printers. Although page 1 of the document is sent along with each section to a printer, page 1 will not print unless it is part of that section of a document. The header information is used by the printers to print the document accurately as desired. In the example of 30 sheets, sheets 1-10 are sent to printer 32. The header information in page 1 is used to print page 1 as well as pages 2-10. Sheets 11-20 are sent to printer 34 along with sheet 1. However, printer 34 does not print page 1, but the header information is used to print pages 11-20. Sheets 21-30 are sent to printer 36 along with page 1. However, printer 36 does not print page 1, but the header information is used to print pages 21-30.

It can be seen that with the method, computer and system described, particular pages can be extracted from a document with a page independent format for printing. In addition, print speed has been maximized at little expense.

The foregoing description of a preferred embodiment of the invention has been presented for purposes of illustration and description. It is not intended to be exhaustive or to limit the invention to the precise from disclosed, and modifications and variations are possible in light of the above teachings or may be acquired from practice of the invention. The embodiment was chosen and described in order to explain the principles of the invention and its practical application to enable one skilled in the art to utilize the invention in various embodiments and with various modifications as are suited to the particular use contemplated. It is intended that the scope of the invention be defined by the claims appended hereto and their equivalents.

What is claimed is:

1. A computer based method for maximizing printing speed of a print job, comprising the steps of:
locating pages in the print job;
creating an index of information relating to the locations of the pages in the print job;
determining if the pages in the print job meet a criteria based on the information in the index;
splitting the print job into a plurality of sets of pages if the pages in the print job meet the criteria; and
delivering said plurality of sets of pages to a plurality of printers, respectively, based on the information in the index.

2. The method of claim 1, wherein the criteria in the determining step is quantity of pages; and wherein the splitting step comprises splitting the print job based on the quantity of pages and a number of printers.

3. The method of claim 1, wherein the print job is split into a plurality of substantially equal sets of pages.

4. The method of claim 1, wherein the step of locating the pages in the print job includes the step of scanning the print job for page markers.

5. The method of claim 4, wherein the step of creating an index of information includes the step of saving the location of the page markers identified during the scanning step.

6. The method of claim 1, further comprising the step of scanning the print job prior to locating pages to determine whether the print job is of the type that is capable of being split.

7. The method of claim 6, further comprising the step of delivering the print job to a printer without proceeding to the locating step, if the print job is not capable of being split.

8. The method of claim 7, further including the step of determining the format of the print job.

9. The method of claim 8, wherein the format is postscript.

10. The method of claim 1, wherein the print job includes a document with a plurality of pages.

11. The method of claim 1, wherein the print job includes a plurality of copies of a document.

12. The method of claim 1, wherein the plurality of sets of pages is printed in duplex on a plurality of sheets.

13. A computer program that causes a computer to perform a method for maximizing printing speed of a print job, the method comprising the steps of:
locating pages in the print job;
creating an index of information relating to the locations of the pages in the print job;
determining if the pages in the print job meet a criteria based on the information in the index;
splitting the print job into a plurality of sets of pages if the pages in the print job meet the criteria; and
delivering said plurality of sets of pages to a plurality of printers, respectively, based on the information in the index.

14. The computer program of claim 13, wherein the criteria in the determining step is quantity of pages; and wherein the splitting step comprises splitting the print job based on the quantity of pages and a number of printers.

15. The computer program of claim 13, wherein the print job is split into a plurality of substantially equal sets of pages.

16. The computer program of claim 13, wherein the step of locating the pages in the print job includes the step of scanning the print job for page markers.

17. A computer used to improve printing speed of a print job in a computer system, comprising:
a first component for locating pages in the print job;
a second component for creating an index with information relating to the locations of the pages in the print job;
a third component for determining if the pages in the print job meet a criteria based on the information in the index;
a fourth component for splitting the print job into a plurality of sets of pages if the pages in the print job meet the criteria; and
a fifth component for delivering said plurality of sets of pages to a plurality of printers, respectively, based on the information in the index.

18. The computer of claim 17, wherein the criteria is quantity of pages; and wherein the fourth component comprises a component for splitting the print job based on the quantity of pages and a number of printers.

19. The method of claim 17, wherein the print job is split into a plurality of substantially equal sets of pages.

20. The computer of claim 17, wherein the component for locating the pages in the print job includes a component for scanning the print job for page markers.

21. A system coupled to a computer network for printing a print job sent by a user connected to the network, the system comprising:
a. a plurality of printers; and
b. computer coupled to the printers for improving printing speed of the print job; the computer comprising:
i. a first component for locating pages in the print job;
ii. a second component for creating an index with the locations of the pages in the print job;
iii. a third component for determining if the pages in the print job meet a criteria based on the information in the index;
iv. a fourth component for splitting the print job into a plurality of sets of pages if the pages in the print job meet the criteria; and
v. a fifth component for delivering said plurality of sets of pages to the plurality of printers, respectively, based on the information in the index.
